(19) United States
(12) Patent Application Publication
(10) Pub. No.: US 2003/0075110 A1
(43) Pub. Date: Apr. 24, 2003

(54) Liquid metering

(76) Inventors: Timothy Clarke, Cloverlea (AU); Laurie Harold, Lillico (AU); Werner Ludwig, Darnum (AU); Peter Julian Moate, Kennett Square (AU); Murray Colbourn Hannah, Buln Buln (AU); Temujin-Storm-Crow Tempest, Warragul South (AU)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/239,465

(22) PCT Filed: Mar. 7, 2001
(86) PCT No.: PCT/AU01/00243

(30) Foreign Application Priority Data
Mar. 24, 2000 (AU) PQ6456

(51) Int. Cl. A01J 3/00; A01J 5/00

(52) U.S. Cl. 119/14.17

(57) ABSTRACT

A milk meter suitable for measuring a quantity of milk flowing through the meter including: a sealed holding chamber (1); entry means (3) for admitting liquid to be measured into the holding chamber; a foam bypass chamber (3); sensing means (5, 7a) for sensing when milk is at or above a predetermined level in said foam bypass chamber, an inlet (13b) arranged to allow communication of milk between the holding chamber and the bypass chamber, the inlet being provided at a level below the predetermined level; drainage means (4, 8) associated with a timer, the drainage means being arranged to allow the milk to drain from the holding chamber for a set period of time (t) in response to a signal from the sensing means; and measuring means (11) arranged to count the number of times (n), milk has been drained from the holding chamber and to display the milk volume and/or flow rate.

### FIELD OF THE INVENTION

This invention relates to methods and devices for metering liquid flow and in a particular non-limiting aspect relates to metering of milk flow during the milking of cows.

### BACKGROUND OF THE INVENTION

Liquid flow devices are needed in a range of industrial and agricultural applications, and particularly in relation to the milking of lactating animals such as cows.

Farmers need to measure the milk yield of individual animals to assist them to efficiently manage the dairy herd. There is also a requirement for farmers to estimate the flow rate of milk for cows to assist in the healthy and efficient milking of cows.

When measuring the flow of, in particular, liquids which are not uniform in composition, such as milk, the milk delivered during machine milking foams due to substantial and varying amounts of entrained air and other gases. As a result an accurate determination of the flow rate of the total mass flow of liquid is difficult to achieve. With milk, the bulk density of the milk and air mix may change substantially during the milking process. It has been found that it can be quite difficult to remove the gas from milk to an extent that will enable acceptable accuracy to be achieved whilst measuring the milk volume during milking or very soon after the milking occurs. As one of the main purposes of measuring the total mass flow is to determine the milk yield from each animal, substantial removal of gas can be achieved by retaining the milk in individual cow portions for a substantial period of time. Clearly this is impractical. A method proposed to overcome the problem of density variation in measuring milk volume is described in U.S. Pat. No. 5,035,139 where the foam profile of milk passing through a chamber is measured by measuring specific densities of the milk at different heights in the chamber. It would, however, be advantageous to measure total mass flow in a more direct manner rather than by making numerous volume and density measurements.

### DISCLOSURE OF THE INVENTION

In one aspect the invention provides a method of measuring a quantity of liquid such as milk which is delivered by a liquid supply line into a holding chamber comprising the steps of:

(i) sensing when essentially bubble free liquid reaches a predetermined level or higher in a holding chamber;

(ii) draining liquid for a constant period (t) from the chamber, whenever the liquid reaches the predetermined level;

(iii) determining the amount of liquid (q) typically drained for each constant period (t);

(iv) recording the number of times the liquid has been drained (n); and

(v) determining the total volume (V) of liquid as a function of the number of times the liquid has been drained (n) over the delivery period (p) multiplied by the amount of liquid (q).

The time (t) for which each drainage event occurs is preferably selected so that milk and milk foam (c) is drained from the collection vessel. Drainage can be controlled by opening and closing a valve.

The rate of inflow of milk to the vessel will vary during milking and the volume of milk drained at each valve opening will vary accordingly. Summation of the number of valve opening events will provide an estimate of milk yield when multiplied by an appropriate constant (q) which is equal to the average quantity of milk that can drain during the above fixed time period (t). A more accurate estimate of milk yield can be made by allowing for the particular dump volume which will occur with various milk inflow rates. The inflow rate can in turn be inferred by the time duration between each successive valve opening. A further improvement in the volume estimation can be made by making an allowance for the volume of milk (c) which will not be automatically drained after the last automatic valve opening after the last high level point has been reached.

The accuracy of the method and hence any device for carrying out the method can be improved by having a milk drainage aperture which allows a milk outflow rate to be considerably greater than or equal to the maximum inflow rate. Where the method is used for determining milking volume for individual cows the aperture should generally be chosen to fall within the range 78 mm² to 314 mm², preferably about 283 m².

Since the limit of metering resolution is equal to the drained volume (q), the accuracy is also improved by causing the volume drained to be small. Thus the drained volume (q) will suitably be chosen to fall within the range 50 ml to 1000 ml more suitably 100 ml to 500 ml and the time (t) in the range 0.5 to 5.0 seconds more suitably about 2 seconds.

In a further aspect the invention provides a milk meter suitable for measuring a quantity of milk flowing through the meter comprising:

(i) a sealed holding chamber;

(ii) entry means for admitting milk to be measured into the holding chamber;

(iii) a foam bypass chamber;

(iv) sensing means for sensing when milk is at or above a predetermined level in said foam bypass chamber;

(v) an inlet arranged to allow flow of milk between the holding chamber and the foam bypass chamber, the inlet being provided at a level below the predetermined level;

(vi) drainage means associated with a timer, the drainage means being arranged to allow the milk to drain from the holding chamber for a set period of time(t) in response to a signal from the sensing means; and

(vii) measuring means arranged to count the number of times (n), milk has been drained from the holding chamber.

The foam bypass chamber may be constructed to prevent or reduce the admission of foam whilst being of a construction which facilitates washing of the meter.

Suitably the timer also measures the time (a) that elapses between the detection of the milk reaching successive predetermined milk levels.

The measuring means is suitably able to calculate the amount of milk which has flowed through the meter by multiplying (n) by (q). It may also add a constant (c) to the resultant figure to take into account the average volume of milk held in any other associated equipment which may retain milk after the flow of milk has stopped eg. milk which remains in the meter and in the long milk tube.

Suitably the volume V may be more accurately estimated by a formula which makes allowance for the effect of varying rate of in-flow on multiple volumes q drained. In this case the amount of milk which has flowed through the hole is the sum of volumes Vᵢ as is explained hereinafter.

The foam bypass chamber is suitably located within the holding chamber. It may include a vertically extending tube which reaches higher than the predetermined level and the height of any foaming liquid in the holding chamber. The tube may be open at its upper end to aid cleaning. It may be of circular cross section. Its lower end may be mounted on a base section which also forms a base for the holding chamber. The inlet may be provided at its lower end.

The sensing means may include a float which floats in the milk with the top of the float body protruding slightly beyond the level of the milk. Thus the float will preferable have a density which is between 0.7 and 1.0, more preferably about 0.85. Suitably the float has a volume in the range 20 ml to 100 ml more preferably about 50 ml. A proximity switch responsive to the level of the float may also be included in the sensing means.

In one construction the float may be in the form of an annulus. It may surround a fixed post provided in the holding chamber. The proximity switch may be provided on either the post or the float with proximity material which can be sensed by the proximity switch being provided on the other of the two.

Alternatively the float may have no post, but instead use the inner wall of the foam bypass chamber for its correct alignment and containment. In this arrangement the sensor switch can be in the meter base and the proximity material can be in the base of the float.

An automatic valve such as a solenoid valve may be included in the drainage means.

### BRIEF DESCRIPTION OF THE DRAWINGS

FIG. 1 is an elevational view of a cross section taken through a milk meter constructed in accordance with the invention;

FIG. 2 is a front sectional view of the milk meter of FIG. 1 connected to a milk line via a manifold; and

FIG. 3 is a graph of milk meter measurements vs actual weight.

### DETAILED DESCRIPTION OF THE PREFERRED EMBODIMENT

A specific construction of a milk meter in accordance with this invention will now be described with the aid of the accompanying drawings.

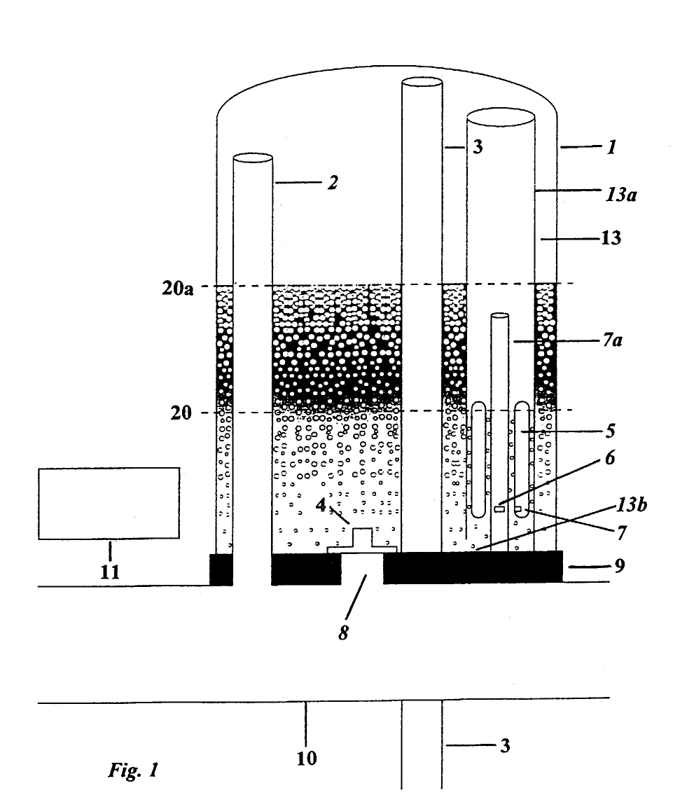

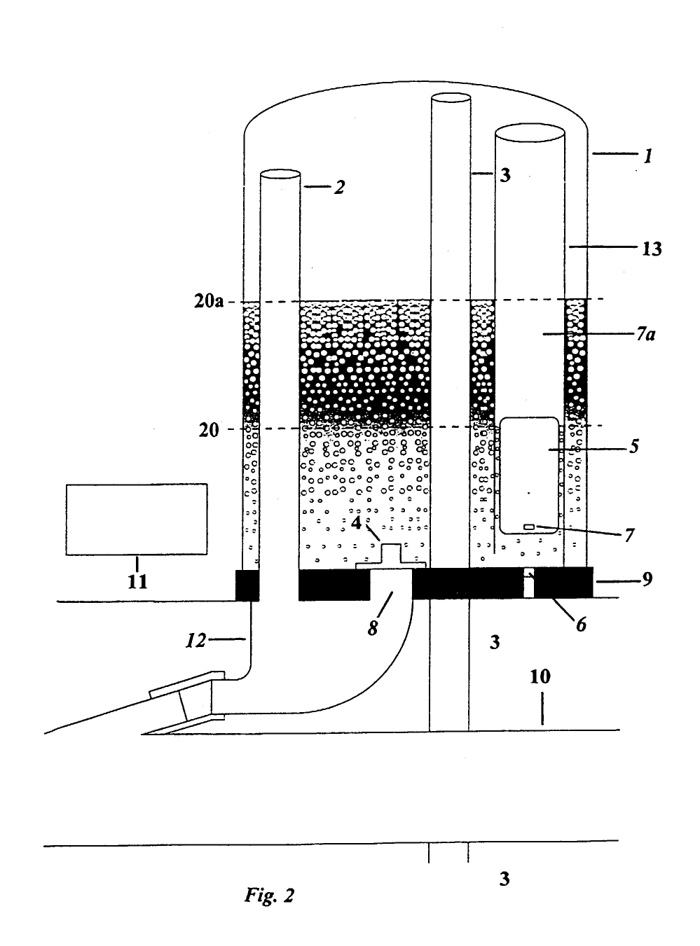

Referring to FIGS. 1 and 2 the milk meter involves a collection vessel I forming a holding chamber for milk being measured. The vessel is sealed to a meter base 9 which has provision for a head space vacuum tube 2 and a calibrated milk drainage hole 8 which are both connected to the evacuated milk line 10. The base 9 may be removable to facilitate cleaning of the meter.

A milk inlet tube 3 from the long milk delivery tube is provided to deliver the milk into the collection vessel 1. A foam bypass chamber 13 in the form of a vertically extending cylinder with an open top 13a is mounted within the collection vessel 1. An inlet 13b provided at the bottom of the cylinder allows flow of milk into the bypass chamber from the collection vessel, the low position of the inlet serving to restrict foaming milk from entering the bypass chamber. The milk outlet hole 8 is sealed by a fast acting valve 4 which is opened for a fixed period of time (t) by the valve controller and timer 11. The valve is triggered by the proximity switch 6 which is activated or deactivated by presence or absence of the proximity material 7 embedded in the float 5 which is housed in foam bypass chamber 13. The float is supported by buoyancy of the milk whose level is shown by the dotted line 20 in the foam bypass chamber 13. The float is annular and surrounds a fixed vertical post 7a in which the proximity switch is embedded. The float may telescopically slide up and down the post with changing milk levels. Beneath the dotted line 20a the milk and foam in the collection vessel exerts the same hydraulic pressure as does the substantially foam free milk below level 20 in foam bypass chamber 13. If the cross sectional area of vessel 1 is essentially uniform between the highest fill level and the low drainage level, then a consistent weight or net volume of milk will be present in the meter at the point in time when the valve opening is initiated. This ensures that, regardless of the foam content of the accumulated milk, the meter contains a standardised quantity of milk at the initiation of each dumping of milk. The dotted line 20a shows a high milk level which activates valve opening.

Manifold 12 is provided for both the drainage of milk to the milk line and the maintenance of the milking vacuum to the collection vessel 1.

The volume of milk and flow rate can be estimated as follows:

V=c+(n×q)

F=q/a

where:

V=volume of milk passed through the meter

F=the flow rate

c=the average volume of milk that will not be automatically drained

n=number of valve openings recorded by the counter

q=the average volume of milk drained during a single drainage period (t)

a=the time that has elapsed between the detection of the previous high level event and the current one

Alternatively, a better estimate of milk yield can be made where the volume of each milk dump is estimated by adjusting it by a factor which allows for the impact of different milk inflow rates on the volume of milk dumped during time t.

$$\begin{matrix}V = c + {\sum }_{i = 1}^{n} {V}_{i .} & equation 1 \\ {V}_{i} = {V}_{o} \frac{d}{{\tilde{a}}_{i} - e} . & equation 2 \\ {F}_{i} = \frac{{V}_{i}}{{\tilde{a}}_{i}} & equation 3 \\ {F}_{n} = \frac{{V}_{o}}{{a}_{n}} & equation 4\end{matrix}$$

Where

V=an estimate of quantity of milk from a milking cow

i=number of milk dumps since the start of milking

n=the number of dumps to the end of milking

c=an estimate of the average quantity of milk that will not be automatically dumped at the end of milking

Vᵢ=the particular quantity of milk that is dumped in time t dumpᵢ.

Fᵢ=an estimate of milk inflow rate which resulted in dumpᵢ

Fₙ=an estimate of terminal milk inflow rate

V₀=the particular quantity of milk dumped in time t when milk in-flow rate approaches zero

d=a constant

e=a constant

constants d and e are selected so that when they are substituted into equation 2, they cause Vᵢ to approximate the amount of milk that is dumped through the valve during valve open time t, for a range of milk inflow rates ranging from zero to the maximum flow rate expected from any cow.

aᵢ=the time that has elapsed between the detection of the current high level event prior to dumpᵢ and the previous high level event.

ãᵢ=smoothed estimate of aᵢ, such as the running average of a (i−1) and aᵢ

A particular combination of the above factors which has given accurate milk yield and flow rate is described below where the milk meter had a chamber diameter of 100 mm and a high liquid level (5) that was 40 mm above the drainage hole (8) which had a diameter of 19.0 mm and a fixed valve open time of 2.00 seconds and was designed to perform with flow rates up to 150 gram/second (9 Kg/minute).

$$\begin{matrix}\begin{matrix}V = c + {\sum }_{i = 1}^{n} {V}_{i} \\ V = 300 + {\sum }_{i = 1}^{n} {V}_{i}\end{matrix} & equation 1 \\ \begin{matrix}{V}_{i} = {V}_{o} + \frac{d}{{\tilde{a}}_{i} - e} \\ {V}_{i} = 234 + \frac{66}{{\tilde{a}}_{i} - 1}\end{matrix} & equation 2 \\ {F}_{i} = \frac{{V}_{i}}{{\tilde{a}}_{i}} & equation 3 \\ \begin{matrix}{F}_{n} = \frac{{V}_{o}}{{a}_{n}} \\ {F}_{n} = \frac{234}{{a}_{n}}\end{matrix} & equation 4\end{matrix}$$

Where

V=an estimate of yield of milk in grams

The flow rate Fₙ from this estimation will be most accurate near the end of milking when flow rate is low. Flow rate in the diary industry is also most important when milk flow is low. Alternatively, if required milk flow rate can also be more generally estimated by Fᵢ at any stage of milking.

If a very high milk inflow rate causes the level switch to be held in the high position after time (t) has elapsed, then successive drainage sequences of time (t) can occur until the normal stop start mode of operation occurs. Under these conditions, the signal from the high level switch can be taken as registering a high reading for multiples of time t until the float falls once more.

It is most desirable for milk meters to be as small as possible so that they can be easily accommodated in the diary shed. The cross sectional area of the collection vessel can be as large as 30,000 mm² or as small as 2,000 mm², but should preferably be about 10,000 mM².

The head height of the liquid at the high level point can be from 20 to 150 mm but more preferably about 40 mm. Time t can be from 0.5 to 5.0 seconds, but more preferably about 2.0 seconds. Drainage holes of 19 mm diameter have been found to be suitable with a time t of about 2 seconds. Smaller diameters could be used, but these would limit the accuracy of the meter at high in-flow rates. Larger diameters could also be used with corresponding smaller valve open times, but larger and possibly slower valves would be required to seal the hole. The float 5 which moves with the liquid milk level is required to have a low enough density to cause it to float in liquid milk but high enough to ensure there is a strong downward force acting upon it when the milk level falls and the float is required to move downwards against surface tension forces from surrounding surfaces. Ester resin filled with suitable amounts of micro glass bubbles for example can be used to make such floats.

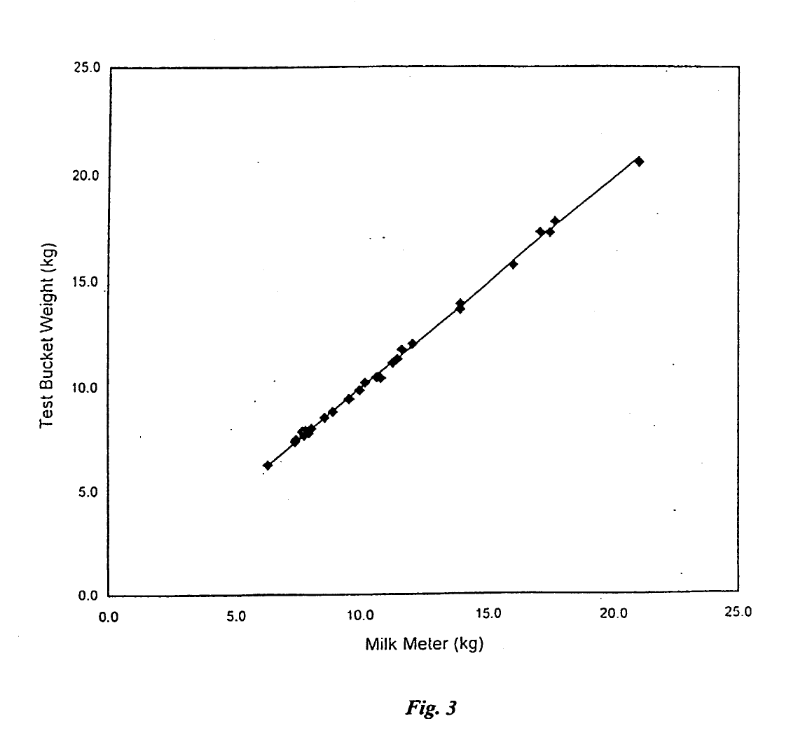

It should be understood that the measurement of milk volume as described in this invention can similarly apply to the estimation of either the volume of weight of milk having due consideration for the mean density of milk. The invention also provides a means of estimating the milk flow rate during milking and this measurement will be most accurate at low inflow rates where milk flow rate information is most needed to monitor the milking process. The milk meter of this invention can be very accurate over a wide range of inflow rates. The measurement principle is such that the accuracy of milk measurement is not greatly dependent on small variations in the size and shape of the collection vessel or the exact determination of the level of milk which triggers the initiation of the milk drainage phase or the rate of inflow of milk from the animal. The graph shown in FIG. 3 demonstrates that high levels of accuracy can be obtained in normal conditions over a wide range of milked volumes.

The simple components required can make it inexpensive to make and easy to clean and service.

The simple operation of the meter is easy to understand and its proper function can consequently be monitored by the farmer.

The meters of this invention can maintain their accuracy even though the milk may be made quite foamy by the particular milking process, milk transport system and or by the diet of the cow.

The output from the device makes it simple to transfer the output data to mechanical or electronic counters, data loggers or a computer and to convert it into milk yield and flow rate estimates according to the above equations.

If the collection vessel is made of transparent material then it is easy to observe the correct function of the device and whether or not cleaning has been effective.

A benefit of the pulsatile dumping of standard milk charges is that it allows simple samplers to take accurately representative samples of milk from a milking.

Furthermore, the holding zone, particularly if it is of small volume may be used to make milk composition measurements in line and to make a composition profile for the milking of each cow. Mastitis detection through conductivity profiles is one real possibility.

It is to be understood that the word comprising as used throughout the specification is to be interpreted in its inclusive form ie. use of the word comprising does not exclude the addition of other elements.

Finally, it is to be understood that the inventive concept can be incorporated in many different constructions and with alternative components so that the generality of the preceding description is not be superseded by the particularity of the attached drawings. Various alterations, modifications and or additions may be incorporated into the various constructions and arrangements of parts or be applied to metering other fluids without departing from the spirit and ambit of the invention.

1. A method of measuring a quantity of liquid subject to foaming which is delivered by a liquid supply line into a holding chamber comprising the steps of:
(i) sensing when substantially bubble free liquid reaches a predetermined level or higher in the holding chamber;
(ii) draining liquid for a constant period (t) from the chamber, whenever the liquid reaches the predetermined level or higher;
(iii) determining the quantity of liquid (q) typically drained for each constant period (t);
(iv) recording the number of times the liquid has been drained (n); and
(v) determining the total volume (v) of liquid over a delivery period (p) as a function of the number of times the liquid has been drained (n) over the delivery period (p) multiplied by the amount of liquid (q).

2. A method according to claim 1 wherein sensing the level of liquid in the holding chamber comprises:
(i) diverting a proportion of essentially bubble free liquid from the holding chamber into a foam bypass chamber under conditions where foamed liquid in the holding chamber is prevented from entering the bypass chamber; and
(ii) sensing the level of liquid in the foam bypass chamber by sensing the level of a float floating in the liquid in the foam bypass chamber.

3. A method according to claim 1 wherein the liquid is milk and the quantity of milk is being measured as it is being milked from a cow by a milking machine.

4. A method according to claim 2 wherein the milk is drained through an aperture having a cross-sectional area falling in the range 78 mm² to 314 mm².

5. A method according to claim 2 wherein the amount of liquid (q) has a volume falling within the range 50 ml to 1000 ml.

6. A method according to claim 2 wherein the amount of liquid (q) has a volume falling within the range 100 ml to 500 ml.

7. A method according to claim 2 wherein the time (t) falls within the range 0.5 to 5.0 seconds.

8. A method according to claim 3 wherein an adjustment is made to the calculation of the total quantity of liquid (V) by inferring the rate of inflow of liquid (F) into the chamber based upon the time elapsed between successive drainages of liquid from the chamber.

9. A milk meter suitable for measuring a quantity of milk flowing through the meter comprising:
(i) a sealed holding chamber;
(ii) entry means for admitting liquid to be measured into the holding chamber
(iii) a foam bypass chamber;
(iv) sensing means for sensing when milk is at or above a predetermined level in said foam bypass chamber;
(v) an inlet arranged to allow flow of milk between the holding chamber and the foam bypass chamber, the inlet being provided at a level below the predetermined level;
(vi) drainage means associated with a timer, the drainage means being arranged to allow the milk to drain from the holding chamber for a set period of time (t) in response to a signal from the sensing means; and
(vii) measuring means arranged to count the number of times (n), milk has been drained from the holding chamber.

10. A milk meter according to claim 9 wherein the measuring means provides a calculation of the amount of milk (V) which has passed through the milk meter by multiplying the (n) by (q).

11. A milk meter according to claim 10 wherein the measuring means is arranged to add a constant (e) to (V) to take account of the average volume of milk which remains in the meter and other associated equipment after flow of milk through the meter has stopped.

12. A milk meter according to claim 9 wherein the measuring means is arranged to calculate the amount of milk (V) which has passed through the milk meter by calculating (V) in accordance with the following equations:
$$\begin{matrix}V = c + {\sum }_{i = 1}^{n} {V}_{i .} & equation 1 \\ {V}_{i} = {V}_{o} \frac{d}{{\tilde{a}}_{i} - e} . & equation 2 \\ {F}_{i} = \frac{{V}_{i}}{{\tilde{a}}_{i}} & equation 3 \\ {F}_{n} = \frac{{V}_{o}}{{a}_{n}} & equation 4\end{matrix}$$
where
i=number of times milk has been drained since the beginning of the milk flow,
n=the number of drainages to the end of milk flow,
c=a constant being an estimate of the average quantity of milk that will not be automatically drained at the end of milking,
Vᵢ=the particular quantity of milk that is drained in time t drain i,
Fᵢ=an estimate of milk inflow rate which resulted in drain i
Fₙ=an estimate of terminal milk inflow rate,
V₀=the particular quantity of milk dumped in time t when milk in-flow rate approaches zero,
d=a constant
e=a constant
and constants d and e are selected so that when they are substituted into equation 2, they cause Vᵢ to approximate the amount of milk that is drained during time t, for a range of milk inflow rates ranging from zero to the maximum flow rate expected from any cow,
aᵢ=the time that has elapsed between the detection of the milk reaching the predetermined level prior to drain i and the previous event of the milk reaching the predetermined level, and
ãᵢ=smoothed estimate of aᵢ, which is the running average of a₍ᵢ₋₁₎ and aᵢ

13. A milk meter according to claim 9 wherein the foam bypass chamber is located within the holding chamber and comprises a tube which reaches higher than the predetermined level, the tube having an open upper end, and the milk meter comprises a base on which the tube and holding chamber are mounted, the inlet being located at or near the base.

14. A milk meter according to claim 9 wherein the sensing means comprise,
a float arranged in the foam bypass chamber, the float having a density of 0.7 to 1.0, and
a proximity switch responsive to the level of the float.

15. A milk meter according to claim 14 wherein the drainage means comprise,
an aperture having a cross sectional area in the range 78 mm² to 314 mm², and
a valve arranged to open and close the aperture in response to signals from the timer and the proximity switch.
